(19) United States
(12) Patent Application Publication
(10) Pub. No.: US 2011/0055264 A1
(43) Pub. Date: Mar. 3, 2011

(54) DATA MINING ORGANIZATION COMMUNICATIONS

(75) Inventors: TORE L. SUNDELIN, DUVALL, WA (US); JAMES C. KLEEWEIN, KIRKLAND, WA (US); BRADFORD R. CLARK, DUVALL, WA (US); JORGE PEREIRA, SEATTLE, WA (US); JAMES J. EDELEN, RENTON, WA (US)

(73) Assignee: MICROSOFT CORPORATION, Redmond, WA (US)

(21) Appl. No.: 12/550,292

(22) Filed: Aug. 28, 2009

(51) Int. Cl. G06F 17/30; G06F 15/16

(52) U.S. Cl. 707/776; 709/206

(57) ABSTRACT

Data mining for organization insights may be provided. Data from a plurality of sources, such as user communications and documents, may be collected. The collected data may be analyzed to identify an insight about users or organizations associated with the communications. The insight may be provided to a user, such as in response to a search query, an analytics tool, or an added application functionality.

### RELATED APPLICATIONS

Related U.S. patent application Ser. No. ______ filed on even date herewith having attorney docket number 14917.1346US01/MS327574.01 and entitled “Data Mining Electronic Communications,” assigned to the assignee of the present application, is hereby incorporated by reference.

### BACKGROUND

Data mining organization communications is a process for providing insights about an organization and its members. In some situations, enterprise communication systems and services may have a strong design bias toward providing features which treat users as individuals who just happen to be members of an organization. Due to this bias, these systems do not provide organization-wide views into collaboration patterns, roles, and key issues of its members or features that might allow members to interact as a community and to contribute to or leverage the collective wisdom of the community. This often causes problems because such data and features may be essential for members to effectively perform their job functions within their respective organizations. Thus, in conventional systems, users often have to improvise and synthesize this functionality in less efficient or effective fashions.

### SUMMARY

Data mining of organization communications may be provided. This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Data mining for organization insights may be provided. Data from a plurality of sources, such as user communications and documents, may be collected. The collected data may be analyzed to identify an insight about users or organizations associated with the communications. The insight may be provided to a user, such as in response to a search query, an analytics tool, or an added application functionality.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing organization insights;

FIGS. 3A and 3B are block diagrams of a user interface for providing organization insights; and

FIG. 4 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Data mining of organization communications may be provided. Consistent with embodiments of the present invention, communication data and metadata, such as e-mails, calendar appointments, IM messages, voicemails, etc., may be analyzed across an organization to produce insights into such factors as the organization's members, communication patterns, relationships, and prioritization of issues. Communication applications such as e-mail and IM clients may be integrated to deliver these insights and power new or advanced functionality. Organization members may thus find top issues and key individuals, understand and leverage the relationships that develop between members, and participate as a community to efficiently categorize and prioritize the vast data they create and exchange.

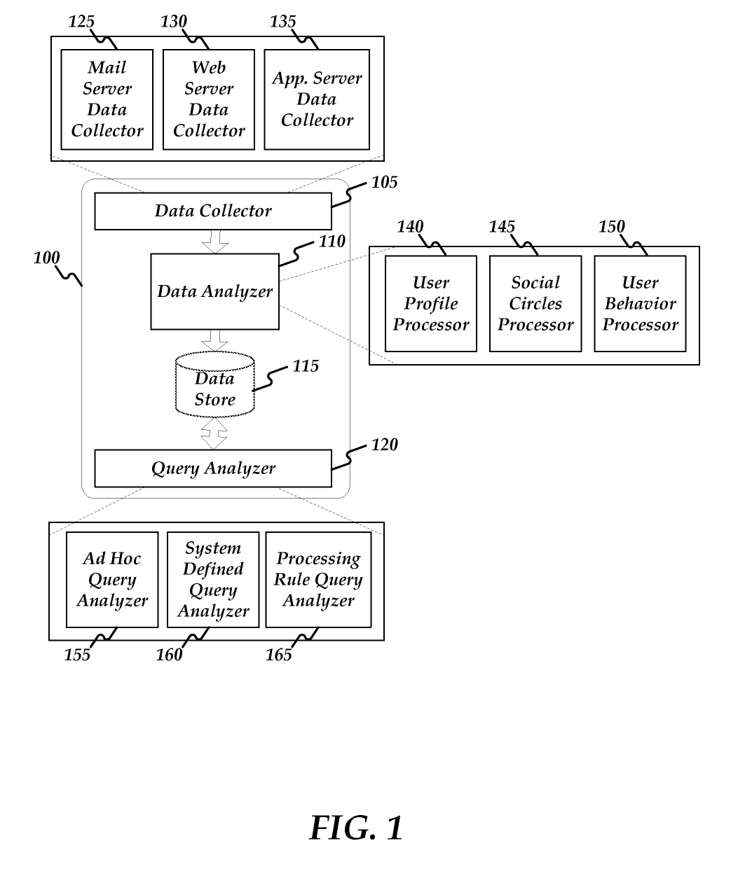

FIG. 1 is a block diagram of an operating environment 100 operative to provide data mining of a user's communications. Operating environment 100 may comprise a data collector 105, a data analyzer 110, a data store 115, and a query analyzer 120. Data collector 105 may collect and aggregate raw data from a variety of electronic communication and related sources, such as e-mail data, web portal data, and directory data. As various sources often package and transmit data in different formats, the invention may be comprised of multiple, logical data collector modules that support these differences, such as a mail server data collector 125, web server data collector 130, and application server data collector 135. Data collector 105 may prepare the collected data prior to and/or as part of analysis. Preparation tasks may comprise cleansing, extraction, and annotation. Cleansing may comprise repair and/or cleanup activities, such as spelling correction and removal of useless or confusing data (e.g. signature lines) from an e-mail message. Extraction and annotation may comprise identifying and/or categorizing key data for use in analysis, such as the identification of a string of characters in an IM message as a contact's name or phone number. Data preparation tasks may vary depending on the data source and/or the type of analysis to be performed. For example, unnecessary white space may be removed prior to analysis, but how this white space is formatted may vary between a calendar appointment and an SMS message and the different logical preparation flows may support these differences.

Once data collection and preparation has been completed, the prepared data may be delivered to data analyzer 110, comprising modules such as a user profile processor 140, a social circles processor 145, and a user behavior processor 150. Each logical data analyzer module may be comprised of multiple types of workflows, such as heavyweight, medium weight, and lightweight batch processing. Heavyweight workflows may be used to generate a new insight or set of insights for a particular user and may require that the analyzer pore over a large data set to determine an accurate value for the insights. Medium weight batch processing may be used to process and analyze new raw data in a batch in order to update existing insights. Lightweight processing may be used in real-time to generate or update insights as data is collected or generated.

Each insight or class of insight may be generated and updated using any and/or all three types of workflows. Consistent with embodiments of the invention, to improve performance of the systems in which it is integrated, the different workflows for a single logical analyzer module, such as user profile processor 140, may be executed on different machines. For example, operating environment 100 may be deployed on a high availability e-mail cluster. The resource intensive batch analysis workflows can execute using the spare cycles of a passive node, while the lightweight, real-time workflows can execute using cycles on the active node.

Query analyzer 120 may produce a variety of insights based on communication patterns, behaviors, and relationships of users. Query analyzer 120 may comprise modules that may analyze and derive insights based on a user's interactions with operating environment 100, such as an ad hoc query analyzer 155, a predefined query analyzer 160, and a processing rule query analyzer 165. Ad hoc query analyzer 155 may receive input from applications that may expose functionality allowing users to formulate ad-hoc searches and sorts using derived insights. For example, a user may request a list of all current “hot” e-mail items, such as a list of all items with a derived priority above a certain threshold. Predefined query analyzer 160 may process application and/or user defined searches, sorts, and filters, such as an an IM application dynamically grouping contacts based on discussion topics or derived relationships. Processing rule query analyzer may allow applications and/or users to create processing rules on communication items based on derived insights. For example, an e-mail application may expose an “auto-attendant” feature that may enable the user to choose to allow the system to organize, flag, and even delete new items based on derived insights into how a user has managed similar items previously. Insights may comprise, for example, profile data, habits, preferences, interests, relationships, areas of expertise, demographic data, priority and/or urgency of a given item or topic, new, derivable items based on the content of existing items, observed and predicted communication item management, triage, and consumption behavior, and/or social or interaction circles and related topics of communication. Insights may be derived based on the analysis of multiple, individual items, such as word processing documents shared with a user on a web collaboration portal and/or multiple types of items, such as e-mail messages, calendar items, and directory data.

Consistent with embodiments of the invention, additional data may be requested for the derivation of a particular insight. For example, when analyzing the priority of a message, directory data on the sender may be requested to determine if he is a peer, report, or manager of the recipient. For another example, to determine topics of interest to a user, content extraction may determine key topics across key data types, such as e-mail messages, calendar items, IM messages, and/or forum posts. A frequency or “hit rate” for each key topic based on the number of communication items pertaining to it may be calculated and modified based on user actions such as whether a user read, ignored, responded, and/or deleted the item. A modifier may also be based on sentiment detection in user responses, such as happy, sad, surprised, liked, disliked, etc.

A stack ranking of “interests” based on modified ratings may be maintained as user insights and may be used to derive still other insights such as the priority of a particular e-mail message. For example, content extraction may be performed on mail messages to determine key topics, those key topics may be compared to the user interest stack ranking, and modifiers may be applied based on the recipient's relationship to the sender (e.g., boss, spouse, friend, random sender on a web forum) and any related calendar appointment data (e.g. time proximity and priority rating of appointments.) A probability or confidence rating may be assigned to insights as appropriate (e.g. 0%>X<100%, where a rating of 100% would represent an irrefutable fact). This confidence rating may depend upon a number of factors including the number and type of sources.

Analysis may comprise an ongoing and iterative process. While some insights may be static (such as gender), others may be dynamic (such as social circles). As new data is processed, the insight as well as its associated confidence rating may change over time. Additionally, time itself can influence both the insight (e.g., age of a user or urgency of an item) as well as its confidence rating (e.g., lack of new data will slowly decay confidence in a user's current address).

Data collected by data collector 105 and/or processed by data analyzer 110 may be stored in data store 115. Insights derived by data analyzer 110 as well as searches and results processed by query analyzer 120 may also be stored in data store 115 and provided to users. For example, users may access and/or query the insights derived by the invention from a plurality of query endpoints. Each of these logical endpoints may vary in either the query syntax and/or query type they support. As an example, some endpoints may support natural language queries (e.g. “Show me all e-mails from my wife”) while other endpoints may require defined syntax queries (e.g. “Type: E-mail, Sender Relationship: Spouse.”) In addition to the query syntax, different endpoints may also support different types of queries, such as ad-hoc queries, user defined queries, system defined queries, and/or processing rules. For ad-hoc queries, applications may expose functionality that allows users to formulate ad-hoc searches and sorts using derived insights, such as requesting a list of all current “hot” e-mail items (e.g., a list of all items with a derived priority above a certain threshold.) User and/or system defined queries may comprise searches, sorts, and/or filters using derived insights created by an application or a user, such as grouping contacts in a communication application based on discussion topics or derived relationships to sender (e.g., friend, co-worker, family.) Processing rules may be created on communication items based on derived insights such as exposing an auto-attendant feature that may enable a user to choose to allow the system to organize, flag, and/or delete new items based on derived insights into how a user has managed similar items previously.

Users may be able to view the derived insights and/or a summary of their derivation. This may help users to know what types of insights are available for use in customizing features in their applications. This may also help users to understand the behaviors of features that act on derived insights and update or correct insights. The ability for users to provide such input can act as a feedback loop to drive better accuracy for a particular insight as well as to tune broader analysis and system behavior. System administrators may be provided with a high degree of control and oversight. For example, administrators may have the ability to control elements such as what data is processed, what insights are derived, who can access the insights, etc.

Data collection and analysis may be performed on a computer or computers acting as servers. This design may provide several benefits, such as allowing a user to view and leverage the same, derived insights from any instance of a communication application. This may enable a unified user experience that spans applications and devices. This may also enable resource constrained devices to be able to leverage complicated insights which their own limited processing capabilities cannot provide effectively. However, the design of the invention allows client software to perform any amount of additional analysis and customization of data and insights locally as may be required by the application and/or the user. Due to the potentially sensitive nature and type of data contained in the insights, a high degree of administrative oversight and control may be provided. Administrators may control settings such as what data is collected and analyzed, what insights are derived, and who may access these insights. Administrators may have coarse control such as determining what data sources to use, but they may also have finer grained control, supported by the creation of organization-wide templates. An example template may comprise “Include all e-mail and calendar items not explicitly marked as ‘private’.” Administrator-defined processing rules may also be supported, such as “Do not include messages sent to the Legal or HR departments unless they have explicitly been marked as ‘public’.” Rights management settings of various communication items may also be respected. Such settings may control whether an item may be included in insight analysis as well as which users may access any associated insights.

To facilitate collaboration between organizations, insights may be shared among multiple parties. Administrators of each parties' insights may have full control over what data is shared and with whom. For example, a manufacturing company and a supplier company may federate with each other, allowing certain insights to be shared with employees at each other's companies. In this way, an employee at the manufacturing company may be able to search for an insight regarding an expert on a particular product line at the supplier company.

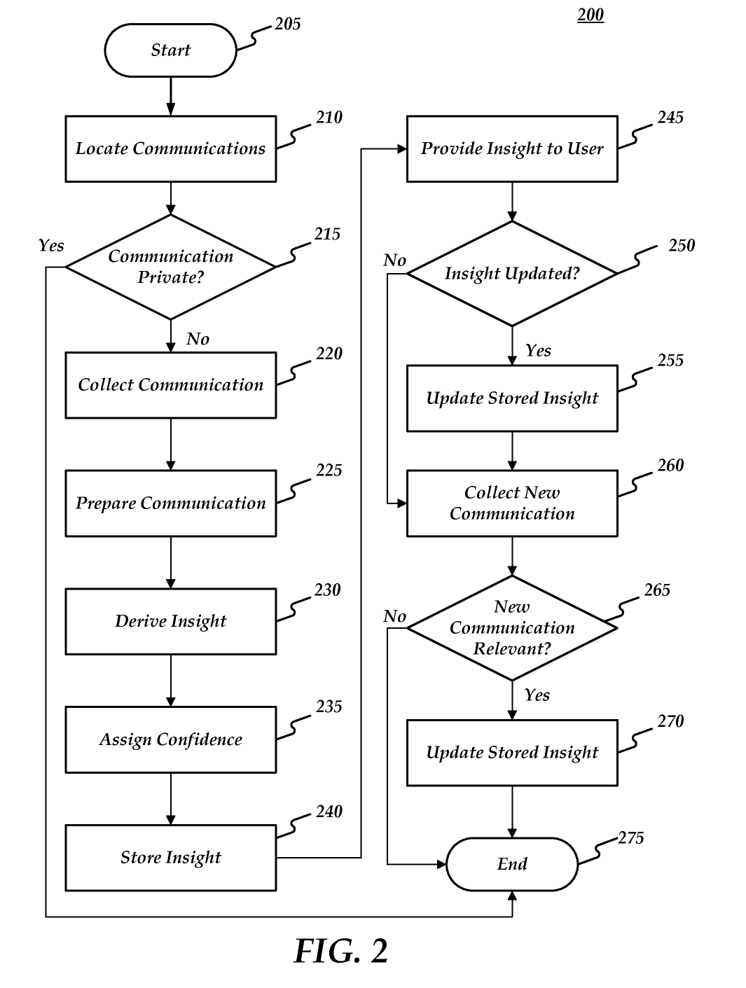

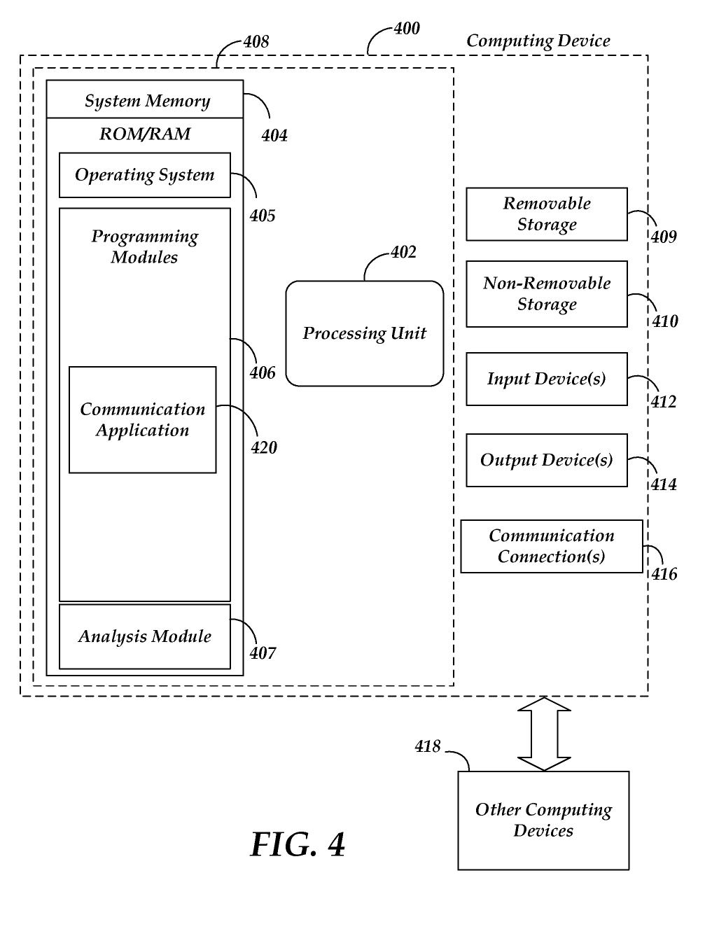

FIG. 2 is a flow chart setting forth the general stages involved in a method 200 consistent with an embodiment of the invention for providing organization insights. Method 200 may be implemented using a computing device 400 as described in more detail below with respect to FIG. 4. Ways to implement the stages of method 200 will be described in greater detail below. Method 200 may begin at starting block 205 and proceed to stage 210 where computing device 400 may locate a plurality of communications. For example, computing device may scan a plurality of servers, clients, devices, and/or networks associated with an organization and locate communications associated with a plurality of users such as an e-mail, a voicemail, a short message service (SMS) message, a shared document, a forum posting, a blog posting, a web page, a status update (e.g., a social network update such as via Twitter or Facebook), an appointment, and/or an instant message (IM).

After collecting the communications at stage 210, method 200 may advance to stage 215 where computing device 400 may determine whether any of the located communications are private. For example, user may explicitly mark an item as private, some and/or all communications associated with a group, project, and/or department (e.g. human resources and accounting) may be treated as private, and/or communications associated with a particular user and/or users (e.g. an organization's attorney) may be treated as private. Consistent with embodiments of the invention, communications determined to be private may be used to derive insights, but such insights may be restricted and accessed by users who have rights to view the associated communication. For example, members of a confidential project may be able to use insights derived from their private communications, but organization users not affiliated with the project may have no access to those insights.

If the communication is private, method 200 may end at stage 275. Otherwise, method 200 may advance to stage 220 where computing device may collect the non-private communication. For example, computing device may copy the communications to data store 115.

From stage 220, method 200 may advance to stage 225 where computing device 400 may prepare the collected communication for analysis. For example, computing device 400 may cleanse the communication, such as by removing extra white space, unneeded information (e.g. signature lines from an email), validating data, and/or performing a spell check. Consistent with embodiments of the invention, preparation of the data may comprise converting the collected communications to a common format. For example, a voicemail recording may be transcribed into electronic text while a calendar appointment may have various properties converted into key/value pairs in a text file. Both text files may comprise, for example, an XML file.

After preparing the communication at stage 225, method 200 may advance to stage 230 where computing device 400 may derive an insight according to the collected communication. For example, a derived insight may comprise a user preference (e.g. display messages in courier font), a user's subject matter expertise (e.g. network routing protocols), a user's project ownership (e.g. lead developer of a new product), a user's decision making authority (e.g. a user with budgetary oversight), and/or a collaboration group (e.g., a group of people working on a product or related group of products, a group of people who regularly communicate with each other, or a group of people working in a given department.) Other example insights may comprise an item management behavior (e.g., moving items from the same sender to a folder, marking a communication as highly rated and/or important, and/or forwarding a message to other users.), an item priority (e.g. urgent and/or low priority), an item rating (e.g., interesting, important, irrelevant, and/or off-topic), a user rating (e.g., helpful or knowledgeable), and/or a subject matter of the communication (e.g., related to a project, product, group, and/or user).

Consistent with embodiments of the invention, a single communication may be used to derive one and/or a plurality of insights, and/or a plurality of communications may be used to derive one and/or a plurality of insights. Further consistent with embodiments of the invention, derived insights may be used to derive further insights, and may be combined with other communications to do so.

Insights may be derived based on factors such as the sender, the recipient, the subject, the type of communication, a treatment of the communication (e.g., deleted, saved, printed, forwarded, or read immediately), and/or metadata associated with the communication (e.g., a user rating or priority.) For example. Computing device 400 may store a count of the number of messages a user sends to each of a plurality of other users and derive an insight comprising a list of the user's most frequent contacts and the user's working group. Communications comprising questions, requests, approvals, and/or answers may help computing device 400 derive insight regarding which users have decision-making authority or subject matter expertise.

Insights may also be derived based on user-generated metadata. This capability may enable features that allow organization members to participate as a community to perform functions such as efficiently prioritizing and/or categorizing vast amounts of data. For example, distribution list recipients may rate messages or senders via mail clients and this data may be collected and analyzed. Organization members may then use derived insights to sort and/or filter messages from the list based on the associated community ratings or tags.

Organizational insights may be provided to users in various ways, such as through customizable application views, community enhanced features, search queries and responses, sharing of insights between organizations, and intelligent archiving. For example, a user may search their organization's directory based on criteria such as group/team, subject matter expertise, and/or key decision makers once appropriate insights are derived. A subject matter expert may be derived, for example, by analyzing which users are most frequently asked about or sent mail on a particular topic. Distribution lists may be searched and/or sorted based on community metadata, such as by retrieving a list of the top 5 current posts in a medium such as a blog, forum, or mailing list, based on user ratings and feedback. Insights may be shared with other organizations enabling users at one organization to access insights associated with a partnered organization, such as an engineer at a manufacturing company being able to search expertise insights associated with employees of a parts supplier. Intelligent archiving may comprise, for example, determining if an item such as an e-mail is work or personal, what project the e-mail is associated with, and/or an importance of the e-mail. Archive settings such as whether, how long, and where to archive the item may be adjusted based on these insights.

From stage 230, method 200 may advance to stage 235 where computing device 400 may assign a confidence to the derived insight. For example, insights may not comprise purely true or false facts, but may be assigned a relative percentage as a confidence. The confidence may be assigned based on a weighting of each of the factors used to derive the insight. For example, an insight comprising designating a user as having budgetary approval authority may increase as the user responds to messages comprising requests for funding with approvals or disapprovals. The confidence may be further boosted based on a company directory listing the user as a senior employee associated with the accounting department.

After assigning a confidence at stage 235, method 200 may advance to stage 240 where computing device 400 may store the insight. For example, computing device 400 may comprise a server computer accessible by users from a plurality of client devices. The insight may be stored on the server and users may access the insights and their associated functionality from multiple locations.

From stage 240, method 200 may advance to stage 245 where computing device 400 may provide the insight to a user. The insight may be provided to the user in a number of different ways, such as by providing an application function (e.g., creating a contact group or message processing rule), sorting, prioritizing, or grouping communications, and/or altering the way a communication is displayed (e.g., changing a color or highlight or changing an order of displayed communications). The insight may also be used to provide a search result in response to a user query, add a tag to at least one communication (e.g., a metadata tag that may be used as a search term), and/or send an alert to the at least one user. Derived insights may also be used when organizing, filtering, and/or formatting non-communication data, such as documents, appointments, database contents, and/or contact directories. For example, insights derived regarding user expertise may be used to filter and/or sort a list of users in a directory.

After providing the insight to a user, method 200 may advance to stage 250 where computing device 400 may determine whether the user has updated the insight, such as by providing feedback (e.g., verifying the accuracy of an insight), providing a rating (e.g., marking an insight that sorts incoming communications as particularly useful), weighting criteria used to derive the insight, and/or enabling or disabling one of the criteria used to derive the insight. For example, an insight may comprise prioritizing communications from a particular user. The insight may be derived based on criteria such as a relationship where the sender is the recipient's supervisor and a pattern of responding to messages from the sender in a short time frame. The user may weight the response time criteria as more important than the sender's identity, for example, and other insights may rely on this weighting when prioritizing incoming communications from other users.

If, at stage 250, computing device 400 determines that the user has updated the insight, method 200 may advance to stage 255 where computing device 400 may update the stored insight. After updating the stored insight at stage 255, or if no user updates to the insight have been received at stage 250, method 200 may advance to stage 260 where computing device 400 may collect another communication. For example, computing device 400 may collect a newly received email for analysis.

After collecting the new communication in stage 260, method 200 may advance to stage 265 where computing device 400 may determine whether the new communication is relevant to the derived insight. For example, the derived insight may prioritize communications from a particular sender. If the new communication matches one of the other criteria used to derive the insight, such as being from the particular sender, the new communication may be deemed relevant. Consistent with embodiments of the invention, method 200 may also return to stage 215 and begin processing the new communication as described above.

If the communication is deemed relevant at stage 265, method 200 may advance to stage 270 where computing device 400 may analyze the new communication and update the stored insight. For example, if the user deletes a new communication without reading it from a sender whose messages had been prioritized by the insight, the updated insight may result in a lowered priority for future messages from that sender. Consistent with embodiments of the invention, the new communication may also be analyzed to derive a new insight. Once the insight is updated, or if the new communication is not relevant to a new and/or an existing insight, method 200 may end at stage 275. Through query analyzer 120 and/or the use of applications that may rely on the insights stored in data store 115, users may provide iterative feedback on the insights. For example, users may specify particular insights of interest, such as project group members, that the user desires to collect and use. The user may also specify insights explicitly with a high confidence rating (e.g., 100%), such as an address, zip code, gender, interests, and/or phone number.

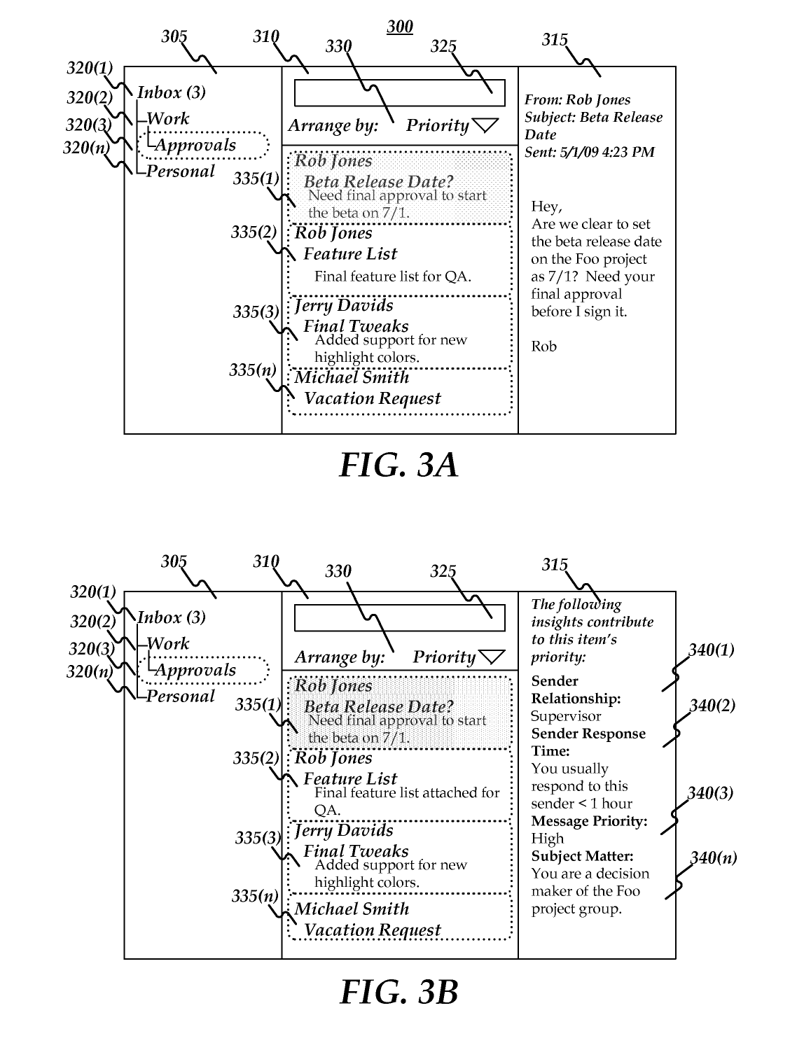

FIG. 3A comprises a block diagram of an example user interface 300 for providing organization insights through data mining. User interface 300 may be associated with a communication application, such as Microsoft Outlook® produced by Microsoft® Corporation of Seattle, Wash. User interface 300 may comprise a folder pane 305, a list pane 310, and a display pane 315. Folder pane 305 may comprise a list of folders 320(1)-320(n) used to store data such as e-mail messages. A selected folder 320(2) may be highlighted in the display of user interface 300 and data stored in selected folder 320(2) may be displayed in list pane 310 as a list of items 335(1)-335(n). For example, items 335(1)-335(n) may each comprise an e-mail message stored in selected folder 320(2).

User interface 300 may further comprise user interface elements for receiving commands from a user such as a search box 325 and a sort control 330. Search box 325 and/or sort control 330 may be operative to interact with stored insights, such as by adding new sorting criteria based on derived insights or returning search results according to the derived insights. The visual prominence of various other user interface elements may be affected by stored insights. For example, a longer or shorter summary of an item may be displayed, a contact picture/icon may be displayed for some important contacts, and/or a preview of an attachment may be shown. Insights based on previous communication triage may drive functionality for moving items with identified characteristics to a particular folder.

Display pane 315 may be operative to display data as requested by the user. For example, a selected item 335(1) may be highlighted in list pane 310 and the contents of selected item 335(1) may be shown in display pane 315. Display pane 315 may update as the user selects other items and/or commands. For example, FIG. 3B comprises a view of user interface 300 as updated in response to a user request to display a list of criteria used to derive an insight. Display pane 315 lists a plurality of criteria 340(1)-340(n) in response to a user command received through a user interface element such as a menu item or a right-click selection. Display pane 315 may also be operative to receive user updates, such as user changes to insight criteria as described above with respect to method 200. Consistent with embodiments of the invention, data displayed in display pane 315 may be displayed in a second user interface window, a dialog box, and/or a tooltip.

An embodiment consistent with the invention may comprise a system for providing communication data mining. The system may comprise a memory storage and a processing unit coupled to the memory storage. The processing unit may be operative to collect data from users, derive insights about the organization's users, and provide a report of the insight to the users. Collected data may comprise an e-mail, an instant message, a voicemail, a shared document, an access log, a metadata element, an SMS message, a forum posting, a blog posting, a web page, a status update, and an appointment. The insight may comprise, for example, a user preference, an area of expertise, an area of ownership, a project membership, a project for which the individual is a decision maker, item management behavior (e.g., message processing rules), and/or a collaboration group or topic. The system may be further operative to receive modifications to the insight, such as user feedback, enabling/disabling of the insight, and/or editing the criteria used to derive the insight. Insights such as decision-making authority and/or subject matter expertise may be associated with users in an organization directory. Consistent with embodiments of the invention, privacy conditions may be associated with the collected data that may prevent the data from being used to derive insights. For example, users may explicitly mark items as private and/or items associated with projects, users, or departments may be treated as private by default.

Another embodiment consistent with the invention may comprise a system for providing data mining of organization communications. The system may comprise a memory storage and a processing unit coupled to the memory storage. The processing unit may be operative to collect data from a plurality of sources, convert the collected data to a common format, analyze the collected data to identify at least one insight, receive a query associated with the at least one insight, and deliver the at least one insight in response to receiving the query. The system may be further operative to assign a confidence to the derived insight and update the insight in response to collecting newly received data.

Yet another embodiment consistent with the invention may comprise a system for providing organization insights. The system may comprise a memory storage and a processing unit coupled to the memory storage. The processing unit may be operative to locate a plurality of communications associated with a plurality of users, determine whether at least one of the located communications comprises a private communication, collect the at least one located communication, and prepare the at least one collected communication for analysis. The system may be further operative to derive at least one insight from the communication, assign a confidence to the insight, store the insight, and provide the insight to at least one user. The system may also determine whether a user has updated the insight or whether a newly received communication is relevant to the insight and update the insight accordingly.

FIG. 4 is a block diagram of a system including computing device 400. Consistent with an embodiment of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the invention. Furthermore, computing device 400 may comprise an operating environment for system 100 as described above. System 100 may operate in other environments and is not limited to computing device 400.

With reference to FIG. 4, a system consistent with an embodiment of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g., random access memory (RAM)), non-volatile (e.g., read-only memory (ROM)), flash memory, or any combination. System memory 404 may include operating system 405, one or more programming modules 406, and may include an analysis module 407. Operating system 405, for example, may be suitable for controlling computing device 400's operation. In one embodiment, programming modules 406 may include a communication application 420, such as an e-mail application. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g., communication application 420) may perform processes including, for example, one or more method 200's stages as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing communication data mining, the method comprising:
collecting data from a plurality of users associated with an organization;
deriving an insight about the organization according to the collected data; and
providing a report of the derived insight to at least one of the plurality of users.

2. The method of claim 1, wherein the gathered data comprises at least one of the following: an e-mail, an instant message, a voicemail, a shared document, an access log, a metadata element, an SMS message, a forum posting, a blog posting, a web page, a status update, a contact, a task item, and an appointment.

3. The method of claim 1, wherein the insight comprises data associated with an individual.

4. The method of claim 3, wherein the insight data associated with the individual comprises at least one of the following: a user preference, an area of expertise, an area of ownership, a project membership, a job title, and a project for which the individual is a decision maker.

5. The method of claim 1, wherein the insight is associated with management of a data item.

6. The method of claim 1, wherein deriving the insight comprises identifying at least one of the following: a collaboration group, a collaboration role, and a collaboration subject.

7. The method of claim 1, further comprising assigning a confidence rating to the insight.

8. The method of claim 1, further comprising receiving input from the at least one of the plurality of users comprising at least one of the following: a feedback rating, an edit to the derived insight, a categorization, a property modification, and an edit to at least one criteria used to derive the insight.

9. The method of claim 1, further comprising associating the derived insight with a user in a directory.

10. The method of claim 1, further comprising establishing at least one privacy condition associated with gathering the data.

11. The method of claim 10, wherein the privacy condition comprises at least one of the following: excluding at least one data item according to an explicit property of the at least one data item and excluding at least one data item according to a category of the at least one data item.

12. A computer-readable medium which stores a set of instructions which when executed performs a method for providing data mining of organization communications, the method executed by the set of instructions comprising:
collecting data from a plurality of sources;
converting the collected data to a common format;
analyzing the collected data to identify at least one insight;
receiving a query associated with the at least one insight; and
delivering the at least one insight in response to receiving the query.

13. The computer-readable medium of claim 12, wherein the at least one insight comprises at least one of the following: a collaboration group, a collaboration role, a subject matter expertise, a decision maker, a popular subject, a collaboration pattern, a user preference, an item management behavior, a job title, and an item priority.

14. The computer-readable medium of claim 12, wherein the plurality of sources are associated with a plurality of users associated with an organization.

15. The computer-readable medium of claim 12, wherein the plurality of sources comprise at least one of the following: an e-mail, an instant message, a voicemail, a shared document, an access log, a metadata element, an SMS message, a forum posting, a blog posting, a web page, a status update, a contact, a task item, and an appointment.

16. The computer-readable medium of claim 12, further comprising assigning a confidence to the at least one insight.

17. The computer-readable medium of claim 12, further comprising determining whether at least one of the collected data comprises a privacy indicator; and
in response to determining that the at least one of the collected data comprises a privacy indicator, disregarding the at least one of the collected data.

18. The computer-readable medium of claim 17, wherein the privacy indicator comprises at least one of the following: an explicit privacy setting associated with the data, an association of the data with a group of users, an association of the data with a department, and an association of the data with a private subject.

19. The computer-readable medium of claim 12, further comprising updating the at least one insight in response to collecting a newly received data.

20. A system for providing organization insights, the system comprising:
a memory storage; and
a processing unit coupled to the memory storage, wherein the processing unit is operative to:
locate a plurality of communications associated with a plurality of users, wherein the plurality of users are associated with an organization and the plurality of communications comprise at least one of the following: an e-mail, a voicemail, an SMS message, a shared document, a forum posting, a blog posting, a web page, a status update, an appointment, a contact, a task item, and an instant message;
determine whether at least one of the located communications comprises a private communication, wherein being operative to determine whether the at least one of the located communications comprises a private communication comprises being operative to determine at least one of the following: whether the at least one located communication has been marked as private, whether the at least one located communication is associated with a project marked as private, whether the at least one located communication is associated with at least one of the plurality of users, and whether the at least one located communication is associated with at least one department of the organization;
in response to determining that the at least one of the located communication does not comprise a private communication, collect the at least one located communication;
prepare the at least one collected communication for analysis, wherein being operative to prepare the at least one collected communication comprises being operative to perform at least one of the following: a spell check, a removal of at least one whitespace character, and a metadata extraction;
derive at least one insight from the at least one collected communication, wherein the at least one insight comprises at least one of the following: a user preference, a user's subject matter expertise, a user's project ownership, a user's decision making authority, a collaboration group, a collaboration role, an item management behavior, an item priority, an item rating, a user rating, a job title, and a subject matter of the communication;
assign a confidence to the at least one insight;
store the at least one insight, wherein being operative to store the at least one insight comprises being operative to make the insight available to at least one user from a plurality of clients;
provide the at least one insight to the at least one user, wherein being operative to provide the at least one insight comprises at least one of the following: provide an application function, sort a plurality of communications, prioritize at least one communication, group a plurality of communications, alter a display of the at least one communication, alter a display of a plurality of communications, provide a search result, add a tag to at least one communication, and send an alert to the at least one user;
determine whether the at least one user has updated the at least one insight, wherein the update to the at least one insight comprises at least one of the following: a rating, a weighting of a criteria used to derive the at least one insight, a disabling of a criteria used to derive the at least one insight;
in response to determining that the at least one user has updated the at least one insight, update the stored at least one insight;
determine whether a newly received communication is relevant to the stored at least one insight; and
in response to determining that the newly received communication is relevant to the stored at least one insight, update the stored at least one insight.
